(19) United States
(12) Patent Application Publication
(10) Pub. No.: US 2025/0362855 A1
(43) Pub. Date: Nov. 27, 2025

(54) METHODS FOR CALENDAR-BASED JOB MANAGEMENT IN A PRINTING SYSTEM

(71) Applicant: KYOCERA DOCUMENT SOLUTIONS, INC., Osaka (JP)

(72) Inventors: Jacek Joseph MATYSIAK, Concord, CA (US); Javier A. MORALES, Rochester, NY (US)

(73) Assignee: KYOCERA DOCUMENT SOLUTIONS, INC., Osaka (JP)

(21) Appl. No.: 18/675,060

(22) Filed: May 27, 2024

(51) Int. Cl. G06F 3/12

(52) U.S. Cl. CPC G06F 3/1263

(57) ABSTRACT

Methods for managing printing operations include querying a job queue at a digital front end (DFE) of a printing device to determine a number of print jobs in the job queue. A production time is estimated for each print job within the job queue. The production time relates to a processing time to print the respective print job at the printing device. Each print job is scheduled within a printing shift in a defined printing schedule according to the production times. Further, the order of the print jobs within the printing schedule is modified according to a condition, policy, or time usage optimization. The order of the print jobs within the job queue are reordered to reflect the modified order in the printing schedule.

### FIELD OF THE INVENTION

The present invention relates to a printing device or system for managing printing operations using calendar-based print job functionality. More particularly, the present invention relates to managing print jobs using calendar-based planning at the printing device.

### DESCRIPTION OF THE RELATED ART

Many systems use a calendar view to manage production printing in printing systems. These systems usually are management information systems or production planning systems. These systems allocate work based on productivity formulas and do not control the digital front ends (DFEs) or printing devices that actually produce the work. These systems also may report actual versus scheduled time but this is generally done after the fact. Although some systems adjust actual time in real-time, the job management at the printing device is done using a flat job list, or, in some cases, a Gantt chart showing each job as bars in a timeline.

Job management systems, such as those described above, do not interact with the printing device. This aspect enables more robust planning and scheduling. This allows calendar-based planning, bulk and manual reordering, and job batching. These functions are enabled because these systems do not need to interact with actual jobs or with the job queue of the printing device. Systems that interact with actual jobs and the job queue of printing devices offer more limited functionality but do not enable more robust planning.

### SUMMARY OF THE INVENTION

A method for managing printing operations is disclosed. The method includes querying a job at a digital front end (DFE) at the printing device to determine a number of print jobs within the job queue. The method also includes estimating a production time for each print job of the number of print jobs within the job queue. The method also includes scheduling each print job of the number of print jobs within a defined printing schedule at the DFE. Each print job is completed without interruption. The method also includes determining a gap within the defined printing schedule. The method also includes further scheduling a first print job of the number of print jobs to be printed within the gap in the defined printing schedule applicable to the printing device.

According to additional embodiments, the step of further scheduling the first print job to be printed within the gap of the defined printing schedule includes changing an order of which the number of print jobs are to be printed. The method also may include reordering the number of print jobs within the job queue according to the changed order.

According to additional embodiments, the step of estimating the production time for each print job includes adding a production penalty to at least one print job of the number of print jobs. The production penalty increases the production time for the at least one print job. According to additional embodiments, the step of estimating the production time for each print job includes adding a maintenance penalty to at least one print job of the number of print jobs. The maintenance penalty increases the production time for the at least one print job.

According to additional embodiments, the method also may include determining a second print job cannot be printed within its slot within the defined printing schedule. The first print job may replace a second print job within the defined printing schedule. The method also may include splitting the second print job to be printed in two slots within the defined printing schedule.

According to additional embodiments, the method may include generating the defined printing schedule for the printing device. The defined printing schedule includes a first portion identified as at least one slot for processing print jobs at the printing device and a second portion identified as at least one slot for not processing print jobs at the printing device.

A method for managing printing operations at a printing device is disclosed. The method includes querying a job queue at a digital front end (DFE) at the printing device to determine a number of print jobs within the job queue. The method also includes estimating a production time for each print job of the number of print jobs within the job queue. The method also includes scheduling each print job of the number of print jobs within a defined printing schedule at the DFE according to a policy applicable to the printing device and the production time for each print job. The method also includes determining a slot within the defined printing schedule. The method also includes further scheduling a first print job of the number of print jobs to be printed within the slot in the defined printing schedule according to the policy applicable to the printing device.

According to additional embodiments, the method may include generating the defined printing schedule for the printing device. The defined printing schedule includes a first portion identified as at least one slot for processing print jobs at the printing device and a second portion identified as at least one slot for not processing print jobs at the printing device.

In some embodiments, the policy includes a policy setting. The policy setting may specify that a first print job is to be processed within a certain amount of time after receipt at the DFE. The policy setting may specify a deadline to complete printing operations of the first print job.

According to additional embodiments, the method may include determining a gap within the defined printing schedule. The gap is located between two scheduled print jobs of the number of print jobs. The method also may include further scheduling a second print job of the number of print jobs to be printed within the gap according to the policy applicable to the printing device.

A method for managing printing operations is disclosed. The method includes querying a job queue at a digital front end (DFE) at the printing device to determine a number of print jobs within the job queue. The method also includes estimating a production time for each print job of the number of print jobs within the job queue. The method also includes reviewing a job setting for each print job to determine a paper media for the respective print job. The method also includes determining a first set of print jobs using a first paper media and a second set of print jobs using a second a paper media. The method also includes scheduling the first set of print jobs within a defined printing schedule at the DFE according to the production times for each print job of the first set of print jobs. The method also includes scheduling the second set of print jobs within the defined printing schedule at the DFE according to the production time for each print job of the second set of print jobs. The second set of print jobs do not overlap with the first set of print jobs at the printing device.

According to additional embodiments, the method may include ordering the first set of print jobs within the job queue. The method also may include ordering the second set of print jobs within the job queue after the first set of print jobs.

According to additional embodiments, the method may include generating the defined printing schedule for the printing device. The defined printing schedule includes a first portion identified as at least one slot for processing print jobs at the printing device and a second portion identified as at least one slot for not processing print jobs at the printing device.

According to additional embodiments, the method may include determining a first sheet size for the first paper media and a second sheet size for the second paper media. The first sheet size may be larger than the second sheet size. The first set of print jobs is printed before the second set of print jobs based on the first sheet size.

A method for managing printing operations is disclosed. The method includes querying a job queue at a digital front end (DFE) of a printing device to determine a number of print jobs within the job queue. The method also includes estimating a production time for each print job of the number of print jobs within the job queue at the DFE. The method also includes scheduling each print job of a number of print jobs within a defined printing schedule at the DFE according to the estimated production time for the respective print job. The method also includes determining a delay in processing a first print job of the number of print jobs according to a status within the printing device. The delay causes a processing time of the first print job to exceed the estimated production time. The method also includes automatically rescheduling, within the DFE, a second print job within the defined printing schedule to accommodate the processing time of the first print job.

According to additional embodiments, the method may include generating the defined printing schedule for the printing device. The defined printing schedule includes a first portion identified as at least one slot of processing print jobs at the printing device and a second portion identified as at least one slot for not processing print jobs at the printing device.

According to additional embodiments, the step of determining the delay in processing the first print job may include determining the status within the printing device is that printing is paused. The set of determining the delay in processing the first print job may include determining an estimated speed of the printing device is below a specified speed corresponding to the estimated production time. The second print job may be scheduled at a specific time within the defined printing schedule so that the specific time is changed based on the delay in processing the first print job.

According to additional embodiments, the method may include determining that the second print job cannot be completed in slots remaining within the defined printing schedule. The method also may include splitting processing of the second print job between different slots within the defined printing schedule. The method also may include reducing a processing time for the second print job within the defined printing schedule. The method also may include cancelling the second print job at the DFE of the printing device. The method also may include alerting an operator of the printing device that the second print job is cancelled.

A method for managing printing operations is disclosed. The method includes querying a job queue at a digital front end (DFE) of a printing device to determine a number of print jobs within the job queue. The method also includes estimating a production time for each print job of the number of print jobs within the job queue at the DFE. The method also includes scheduling each print job of a number of print jobs within a defined printing schedule at the DFE according to the estimated production time for the respective print job. The method also includes removing a first print job from a first slot within the defined printing schedule. The first print job is placed in a holding status for the defined printing schedule. The method also includes removing the first print job from the holding status. The method also includes scheduling the first print job at a second slot within the defined printing schedule. The estimated production time for the first print job does not overlap a third slot for a second print job.

According to additional embodiments, the method may include generating the defined printing schedule for the printing device. The defined printing schedule includes a first portion identified as at least one slot of processing print jobs at the printing device and a second portion identified as at least one slot for not processing print jobs at the printing device.

According to additional embodiments, the method may include shifting the third slot for the second print job based on the estimated production time for the first print job. The third slot for the second print job may be a specific time slot that is fixed within the defined printing schedule. The method also may include shifting the second print job or a third print job to the first slot vacated by the first print job within the defined printing schedule.

A method for managing printing operations is disclosed. The method includes querying a job queue at a digital front end (DFE) of a printing device to determine a number of print jobs within the job queue. The method also includes estimating a production time for each print job of the number of print jobs within the job queue at the DFE. The method also includes scheduling each print job of a number of print jobs within a defined printing schedule at the DFE according to the estimated production time for the respective print job. The method also includes determining a status for a first print job scheduled at a first time slot within the defined printing schedule. The method also includes changing the estimated production time for the first print job based on the status. The method also includes determining the first print job cannot be processed at the first time slot. The method also includes sending an alert using the DFE that the first print job is not able to be processed at the first time slot.

In some embodiments, the status corresponds to a delay in processing the first print job. The step of determining the first print job cannot be processed at the first time slot may include determining the first print job has a fixed processing time within the defined printing schedule.

According to additional embodiments, the method may include rescheduling the first print job to a second time slot within the defined printing schedule. The method also may include determining that first print job cannot be processed at the second time slot. The method also may include sending another alert using the DFE that the first print job is not able to be processed at the second time slot.

According to additional embodiments, the method may include rescheduling the first print job to a second time slot within the defined printing schedule. The method also may include shifting a second print job within the defined printing schedule.

A method for managing printing operations at a printing device is disclosed. The method includes querying a job queue at a digital front end (DFE) of the printing device to determine a plurality of print jobs within the job queue. The plurality of print jobs is in an order within the job queue. The method also includes estimating a production time to print each print job of the plurality of print jobs in the job queue at the printing device. The method also includes defining a shift in a defined printing schedule for using the printing device to print the plurality of print jobs. The shift includes a start time and a stop time for printing operations at the printing device. The shift includes a plurality of time slots between the start time and the stop time. The method also includes scheduling the plurality of print jobs within the shift of the defined printing schedule using the plurality of time slots according to the production time for each print job within the DFE. The order within the job queue is modified based on the plurality of time slots for the plurality of print jobs. The method also includes indicating a first print job is not able to be printed within the shift based on the scheduled plurality of print jobs. The method also includes adjusting the shift within the defined printing schedule. The method also includes inserting the first print job into a time slot within the shift. An amount of unused time within the shift is reduced. The method also includes reordering the first print job within the job queue of the DFE.

According to additional embodiments, the method may include generating the defined printing schedule for the printing device. The defined printing schedule includes a first portion identified as at least one time slot for processing print jobs at the printing device and a second portion identified as at least one time slot for not processing print jobs at the printing device. The shift may be defined in the first portion of the defined printing schedule.

According to additional embodiments, the method may include determining a gap between a first time slot and a second time slot in the shift. The method also may include reordering the plurality of print jobs within the shift to reduce a size of the gap. The method also may include reordering the plurality of print jobs within the job queue to match the order of print jobs within the shift.

According to additional embodiments, the method may include printing the plurality of print jobs at the printing device according to the defined printing schedule. The method may include printing the first print job at the printing device as specified within the defined printing schedule. The method may include determining a second print job of the plurality of print jobs uses a fixed time slot within the defined printing schedule. The fixed time slot does not change if the first print job being reordered causes a reordering of the plurality of print jobs.

According to additional embodiments, the step of inserting the first print job into the time slot within the shift may include inserting the first print job into the time slot after a previous time slot for a second print job. The first print job and the second print job use a paper media. The step of inserting the first print job into the time slot within the shift includes inserting the first print job into the time slot after a previous time slot for a second print job. The first print job and the second print job use a first paper tray.

A method for managing printing operations at a printing device is disclosed. The method includes querying a job queue at a digital front end (DFE) of the printing device to determine a plurality of print jobs within the job queue. The plurality of print jobs is in an order within the job queue. The method also includes estimating a production time to print each print job of the plurality of print jobs in the job queue at the printing device. The method also includes defining a shift in a defined printing schedule for using the printing device to print the plurality of print jobs. The shift includes a start time and a stop time for printing operations at the printing device. The shift includes a plurality of time slots between the start time and the stop time. The method also includes scheduling the plurality of print jobs within the shift of the defined printing schedule using the plurality of time slots according to the production time for each print job within the DFE. The order within the job queue is modified based on the plurality of time slots for the plurality of print jobs. The scheduling includes determining a first print job and a second print job of the plurality of print jobs include an attribute. The scheduling also includes scheduling the first print job in a first time slot within the shift. The scheduling also includes scheduling the second print job in a second time slot immediately following the first time slot. The scheduling also includes reordering the second print job within the job queue of the DFE.

In some embodiments, the attribute of the first print job and the second print job is a paper media. In other embodiments, the attribute of the first print job and the second print job is a paper size. In other embodiments, the attribute of the first print job and the second print job is an output bin of the printing device. In other embodiments, the attribute of the first print job and the second print job is a job setting.

According to additional embodiments, the method may include generating the defined printing schedule for the printing device. The defined printing schedule includes a first portion identified as at least one time slot for processing print jobs at the printing device and a second portion identified as at least one time slot for not processing print jobs at the printing device.

A method for managing printing operations at a printing device is disclosed. The method includes querying a job queue at a digital front end (DFE) of the printing device to determine a plurality of print jobs within the job queue. The plurality of print jobs is in an order within the job queue. The method also includes estimating a production time to print each print job of the plurality of print jobs in the job queue at the printing device. The method also includes defining a shift in a defined printing schedule for using the printing device to print the plurality of print jobs. The shift includes a start time and a stop time for printing operations at the printing device. The shift includes a plurality of time slots between the start time and the stop time. The method also includes determining at least one gap having an amount of time between at least two time slots within the plurality of time slots based on an order of the plurality of print jobs within the job queue of the DFE. The method also includes automatically reordering the plurality of print jobs within the plurality of time slots of the defined printing schedule to reduce the amount of time of the at least one gap between the at least two time slots. The method also includes changing the order of the plurality of print jobs within the job queue of the DFE to correspond to the reordered plurality of print jobs within the defined printing schedule.

According to additional embodiments, the method may include generating the defined printing schedule for the printing device. The defined printing schedule includes a first portion identified as at least one time slot for processing print jobs at the printing device and a second portion identified as at least one time slot for not processing print jobs at the printing device.

According to additional embodiments, the method may include determining a first print job and a second print job of the plurality of print jobs include an attribute. The method also may include scheduling the first print job in a first time slot within the shift. The method also may include scheduling the second print job in a second time slot immediately following the first time slot. The method also may include reordering the second print job within the job queue of the DFE. According to additional embodiments, the method may include printing the plurality of print jobs at the printing device according to the defined printing schedule.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Various other features and attendant advantages of the present invention will be more fully appreciated when considered in conjunction with the accompanying drawings.

FIG. 1A illustrates a printing system having a printing device for printing documents according to the disclosed embodiments.

FIG. 1B illustrates a digital front end (DFE) for a printing device according to the disclosed embodiments.

FIG. 2 illustrates a block diagram of components of the printing device for use within the printing system according to the disclosed embodiments.

FIG. 3 illustrates a block diagram of a job queue of the DFE used in conjunction with a printing schedule calendar application according to the disclosed embodiments.

FIG. 4 illustrates a block diagram of a defined printing schedule to schedule print jobs using information derived from the job queue according to the disclosed embodiments.

FIG. 5 illustrates a block diagram of another defined printing schedule to schedule print jobs using information derived from the job queue according to the disclosed embodiments.

FIG. 6 illustrates a block diagram of another defined printing schedule to schedule print jobs according to the disclosed embodiments.

FIG. 7 illustrates a flowchart for managing printing operations using a calendar application at the printing device according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a printing system that enables sophisticated, calendar-based planning directly on the printing device. The disclosed system interacts directly with the DFE job queue and the jobs within the queue.

In some embodiments, the operator may define a pattern of available work hours for the printing device. The operator may specify a plurality of settings. These settings include working days, which may be the days of the week during which the printing device is expected to do work. The settings also include holidays. These may be days of the year that would be exceptions to the above pattern. The disclosed system may offer the operator the option to subscribe to a normal (.ics) calendar to define these exceptions. When using a standard calendar for planning, the disclosed system may skip days with events when planning production using the calendar subscriptions.

For each workday, the operator may specify start and end, or stop, times for each day of the week. The operator would then specify meetings that would represent non-work hours during the day. The disclosed system may allow the operator to subscribe to a normal (.ics) calendar to define non-work hours. This feature would allow operators to plan non-work hours using any calendar application on any device. The disclosed system would skip these times when planning production printing. The planning time may relate to the number of hours that should be planned using this view. The operator also may adjust the start and stop times as well as the non-work hours for any given day. This action may be done in the DFE user interface. Alternatively, this action may be done by editing the subscribed calendar.

Once work hours are defined, the disclosed system parses the active job list in order to populate the calendar view. The disclosed system analyzes print jobs in the sequence in which they are in the job queue and determines estimated print times using job properties.

The disclosed system estimates the production time for each print job. An initial estimate may be based on a number of pages, copies to print, sheet size, inline finishing, resolution (which may impact print speed), media attributes, and the like. For example, heavier media may run slower in toner devices. Production penalties may be added to the above estimates. Print ticketing exceptions may each incur a penalty that is added to the estimated print time. Print ticketing exceptions include changes in media, plex, inline finishing, and the like. Periodic maintenance, such as head purging, also may incur penalties that are added to the above estimates.

Once a job is estimated, it is added to the calendar as an appointment. Print jobs are automatically added within the work hours and around non-work hour appointments. The disclosed system also may schedule using one or more policies. These policies may include a policy to ensure job contiguity so that print jobs only are scheduled into a time in the calendar where the print job may be completed without interruption. The disclosed system may reorder jobs in the queue to fill, as much as possible, gaps in the schedule. If there are multiple print jobs that may be used to fill gaps in the schedule, then the disclosed system may give preference to print jobs that minimize changes in media.

The policies also may include a policy to print jobs in the defined sequence. Jobs that cannot be completed before non-work hour appointments are automatically divided into multiple appointments. Alternatively, if the print job can be completed within a certain amount of time within the non-work hours, then the disclosed system may schedule the print job contiguously and move the specific instance of the non-work hours appointment. Whether an appointment can be moved or not is specified as an option for each non-work hours appointment.

The disclosed system also may offer “1-click” optimizations to the schedule. These optimizations may include minimizing idle time by ensuring all work hours are filled as much as possible. In order to enable this feature, the disclosed system may have policy settings related to job completion. The disclosed system may specify that a print job must start production within a certain amount of time after it is received at the printing device. The job information may include deadlines, either external or internal, that the disclosed system may use to determine the window within which the print job may be scheduled.

The optimizations also may include maximizing productivity to minimize operator interventions. This may be accomplished by minimizing the number of media changes by batching print jobs that use the same media. This also may be accomplished by minimizing output bin unloads by scheduling print jobs from the largest sheet to the smallest sheet on a per output bin basis.

The disclosed system also may publish the calendar as a standard calendar so any calendar application can subscribe to the DFE queue in this manner. The disclosed system also may even let operators manage the queue from their calendaring applications by moving, but not resizing, appointments.

In addition, the appointments for specific print jobs are updated based on actual job production time. If production stops for a print job, then the appointment continues to grow as long as production has paused. Similarly, if the print job does not render or print at the estimated speed then the disclosed system will extend the appointment. When an appointment is extended, the disclosed system will automatically push other print jobs further down the list. If an appointment is extended so that it pushed a print job that is scheduled at a specific time then that print job also is pushed down. Its scheduling is changed so that it prints relative to the previous print job.

If an appointment is extended into a non-work hour, then an action may occur. This action may include splitting the print job into multiple appointments if the non-work hour cannot be moved. Alternatively, the action may include pushing or reducing the size of the non-work hour if the non-work hours can be moved for the print job. If a print job is cancelled, then other appointments are pushed up to fill the newly available space in the calendar.

As time passes, the disclosed system will continually schedule additional jobs based on available space at the end of the scheduled time. The disclosed system also may display unscheduled print jobs separately. The operator may manually move print jobs in and out of the unscheduled area. Alternatively, the operator optionally may include unscheduled print jobs when performing 1-click operations.

Thus, the disclosed embodiments enable production planning using the actual device queue and the print jobs contained within that queue. This allows for highly interactive planning using actual print jobs as opposed to information about such jobs.

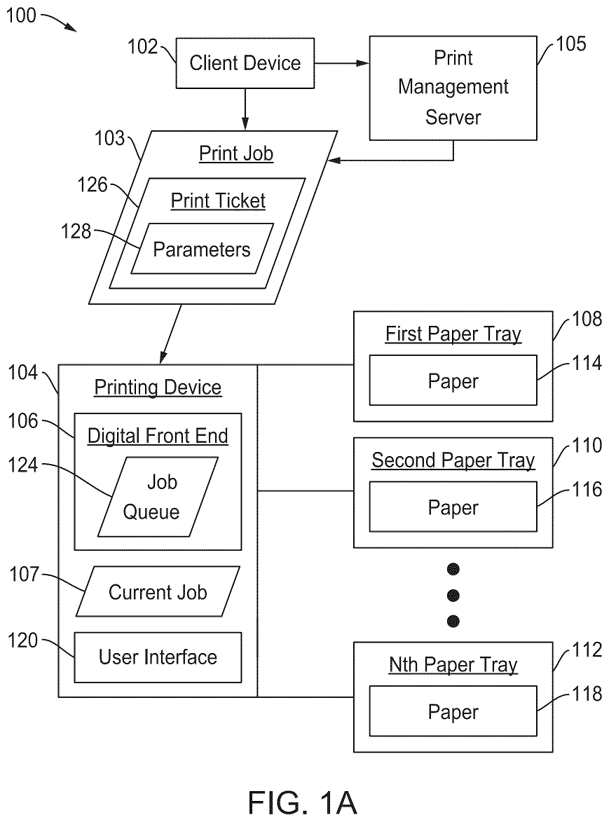

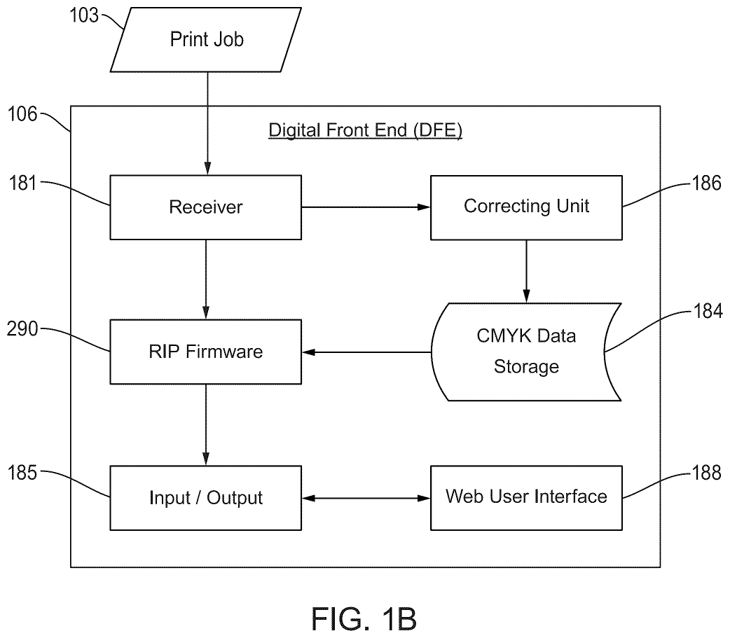

FIG. 1A depicts a printing system 100 for printing documents according to the disclosed embodiments. Printing system 100 includes printing device 104. Printing device 104 is disclosed in greater detail below. Printing device 104 may receive one or more print jobs 103 within printing system 100. For example, client device 102 may generate and send print job 103 to printing device 104. In some embodiments, printing device 104 may be a production printing device in that print jobs are provided through client device 102, which is attached to the printing device. Such a print job may require 1000s of pages or even 100,000 pages or more.

Print job 103 may include a print ticket 126 that sets forth one or more parameters 128 for the print job. For example, print ticket 126 may specify a size for a sheet of print job 103 as well as weight, quality of paper, color of paper, punched holes, and the like. The operator may generate print ticket 126 when submitting print job 103 for printing within printing system 100. Information from print ticket 126, such as one or more parameters 128, may be used to generate a production time to complete printing operations for print job 103.

Printing device 104 may receive print job 103 as it is processing and printing current job 107. Current job 107 may use different paper or media than print job 103. As such, printing device 104 may include a plurality of paper trays to supply papers of various types, sizes, weights, and the like. Thus, printing device 104 includes first paper tray 108 having paper 114, second paper tray 110 having paper 116, and so on to Nth paper tray 112 having paper 118. Current job 107 may use paper from one or more of these paper trays. In some embodiments, paper 114, paper 116, and paper 118 are different types of paper or different media. For example, current job 107 may use paper 116 from second paper tray 110 while print job 103 may require paper 114 from first paper tray 108.

User interface 120 may be in operation panel 208, disclosed below, or part of digital front end (DFE) 106. DFE 106 is disclosed in greater detail below. DFE 106 may process print jobs and act as a controller for printing device 104. Alternatively, user interface 120 may be displayed on client device 102. The disclosed embodiments may use user interface 120 to select papers for print job 103.

DFE 106 also includes print job queue 124. Job queue 124 may be a register that includes print jobs 103 that are waiting to be sent print engine 260, disclosed below. In some embodiments, DFE 106 may include more than one job queue 124. The different job queues may be based on some criterion such as urgent jobs or jobs requiring special finishing or some other operation. Print jobs in job queue 124 may be assigned a status. For example, print jobs within job queue 124 may be designated as being received, parsed, rendered, printed, or already printed. Job queue 124 is a local queue in that it resides on DFE 106.

FIG. 1B depicts a block diagram of DFE 106 according to the disclosed embodiments. DFE 106 includes a receiver 181, a RIP firmware 290, a CMYK data storage 184, an input/output connector 185, and a correcting unit 186. Additional components within DFE 106 may be implemented, as disclosed above and below. For example, although job queue 124 is not shown in FIG. 1B, it is part of DFE 106.

Receiver 181 receives print job 103 received within system 100 and outputs the print job to RIP firmware 290. In some embodiments, receiver 181 receives print job 103 from job queue 124. Receiver 181 also may receive color information for the document or documents within the print job. It may output the color information to correcting unit 186. The print job received by receiver 181 is associated with image data to be printed on print media. It also may include print condition information including information for indicating single-sided printing or two-sided printing or print medium-type information along with other data associated with the print job.

RIP firmware 290 converts image data associated with the print job into raster data to thereby generate rendering data, and outputs the generated rendering data. RIP firmware 290 also converts the rendering data into rendering data in a CMYK format. When the rendering data is originally in the CMYK format, or CMYK rendering data, the conversion may not be performed. RIP firmware 290 may perform gradation conversion of the CMYK rendering data, with reference to one or more tone reproduction curves (TRCs). A TRC refers to data indicating the relationship between a colored gradation value for rendering data and print color, or print density, on a given print medium.

When print color provided alters over time, the TRCs stored in CMYK data storage 184 may be each deviated from an actually measured relationship between a colored value and print color. When the TRC is shifted from the actual relationship, gradation conversion for each colored gradation value cannot match a desired print color. In this regard, correcting unit 186 corrects the deviation, from the actual relationship, of the TRC stored in CMYK data storage 184 in order to allow each colored gradation value to match a desired print color. Correcting unit 186 converts RGB color information obtained through receiver 181 into CMYK color information. Correcting unit 186 may use the converted CMYK color information to generate the TRC. The TRC stored in CMYK data storage 184 is replaced with the generated TRC. Correcting unit 186 may correct the TRC. Correcting unit 186 may rewrite a part of the TRC stored in CMYK data storage 184 to thereby correct the TRC.

The rendering data generated by RIP firmware 290 may be transmitted within printing system 100 via input/output connector 185. The print condition information and the print medium type, as well as the rendering data, may be transmitted to a selected printing device within printing system 100. As disclosed above, the rendered data may be in a file format acceptable for a printing device such that the print job is provided directly to the print engine of the printing device.

DFE 106 also includes web user interface 188 that may communicate with other devices within printing system 100, if it is located at a separate device, using, for example, input/output connector 185. Web user interface 188, or web application, allows a user of the DFEs of other printing devices to interact with content or software running on DFE 106.

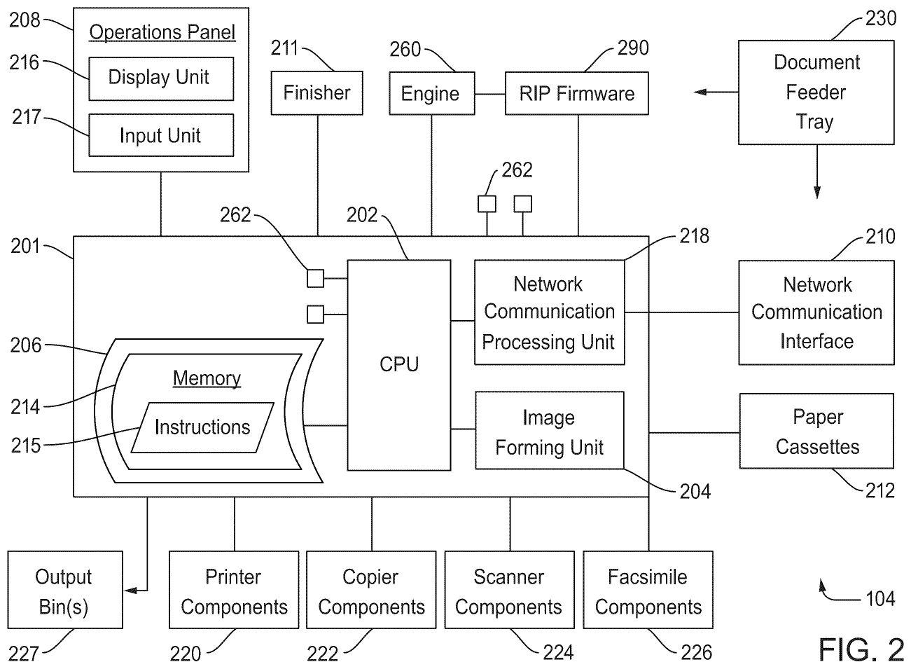

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within system 100. As disclosed above, printing device 104 may send and receive data from DFE 106 and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays, shown as paper trays 108, 110, and 112 in FIG. 1A. Paper cassettes 212 may include papers having various sizes, colors, composition, and the like. Papers or media within paper cassettes 212 may be considered “loaded” onto printing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from DFE 106, if applicable. DFE 106 may send calibration and paper catalog information to printing device 104 for display. For example, the operator at DFE 106 may send a calibration to printing device 104. Printing device 104 displays paper type and any other information needed to complete the calibration.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on printing device 104.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device. Memory unit 206 may store the history of failure events and occurred errors with a timestamp of each error.

Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from DFE 106 as well as other devices within system 100.

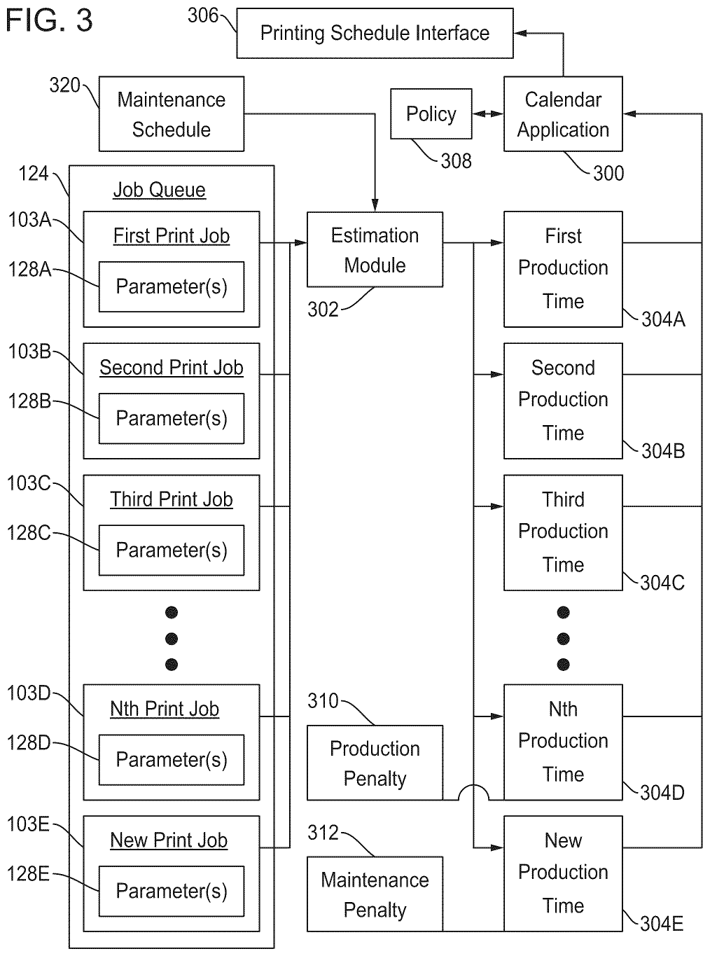

FIG. 3 depicts a block diagram of a job queue 124 of DFE 106 used in conjunction with a printing schedule calendar application 300 according to the disclosed embodiments. Calendar application 300 operates in conjunction with DFE 106 and job queue 124 to schedule and process print jobs at printing device 104. Calendar application 300 interacts with job queue 124 to meet the requirements of the actual jobs within the queue. Calendar application 300 also manages printing schedule interface 306, which is displayed to the operator at printing device 104 through user interface 120. Alternatively, printing schedule interface 306 may be displayed at client device 102.

Calendar application 300, however, resides and is located at DFE 106. In some embodiments, calendar application 300 is not an “application” as a separate component within DFE 106. It may be comprised of components within DFE 106, including processor 202 and memory 206, disclosed above. Instructions 215 are executed to provide the functionality disclosed herein for calendar application 300. Preferably, calendar application 300 operates in DFE 106 to have access to job queue 124. Alternatively, calendar application 300 may operate in management server 105 but has access to DFE 106.

Job queue 124 includes a plurality of print jobs. The print jobs may be ordered in the queue such that a job at the top of job queue 124 is processed and printed first. In the disclosed embodiments, however, print jobs are printed according to a printing schedule determined by calendar application 300. An example printing schedule is disclosed in greater detail below.

Calendar application 300 parses an active print job list within job queue 124 to populate the printing schedule shown within printing schedule interface 306. Estimation module 302 estimates a production time for each print job within job queue 124. For example, job queue 124 may include first print job 103A, second print job 103B, third print job 103C up to Nth print job 103D. Additional print jobs may be within job queue 124 between third print job 103C and Nth print job 103D. Job queue 124 may receive new print job 103E as a new job submitted to printing device 104.

Each print job also may include one or more parameters related to parameters 128 specified in a print ticket 126 with the respective print job. Thus, first print job 103A includes one or more parameters 128A. Second print job 103B includes one or more parameters 128B. Third print job 103C includes one or more parameters 128C. Nth print job 103D includes one or more parameters 128D. New print job 103E includes one or more parameters 128E. It should be noted that parameters 128A-E differ from each other in terms of values for the parameters and the actual parameters themselves. Each print job may have different parameters.

Estimation module 302 may generate a production time for each print job entry within job queue 124. The production time also may be referred to as the print time. An initial estimate for the production time for a print job may be based on parameters provided with the print job, such as the number of pages, copies to print, sheet size, inline finishing, resolution that also may affect print speed, media attributes, and the like. Media attributes may be important as heavier media may run slower in toner devices.

Thus, estimation module 302 may estimate a first production time 304A for first print job 103A. It also may estimate a second production time 304B for second print job 103B. Estimation module 302 also estimates a third production time 304C for third print job 103C and an Nth production time 304D for Nth print job 103D. When new print job 103E is received in job queue 124, estimation module 302 estimates a new production time 304E.

In addition to the initial estimates for production times, estimation module 302 also considers production penalties that are added to the initial estimates. Production penalties may relate to print ticketing exceptions, such as changes in media, plex, inline finishing, and the like. These actions may incur a penalty that is added to the estimated production time. For example, for a change in media, first paper tray 108 may be removed and refilled with the specified media, which results in additional time over the initial estimated time. Parameters 128D for Nth print job 103D may require a change in media at printing device 104 so that estimation module 302 places a production penalty 310 into Nth production time 304D.

Estimation module 302 also may consider periodic maintenance, or maintenance penalties, in addition to the initial estimates. Periodic maintenance, such as head purging, occurs regardless of print jobs in that they are not caused by parameters within a print job. Instead, maintenance penalties are related to actions specified by printing device 104 that incur penalties for printing a job. Thus, estimation module 302 may take into account maintenance schedule 320 when estimating production times for print jobs within job queue 124. For example, periodic maintenance may need to occur according to maintenance schedule 320 during the printing of new print job 103E. Estimation module 302 adds maintenance penalty 312 to new production time 304E for new print job 103E.

Once a production time is estimated for a print job, an appointment for the print job is added to the printing schedule by calendar application 300. This process is disclosed in greater detail below. The print jobs include specified scheduling parameters that also need to be taken into account when scheduling the appointments, such as time slots, available time in the printing schedule, pinned or set print times within the printing schedule, and the like. Calendar application 300 also may take into account policy 308 for printing device 104. Policy 308 may specify actions to be taken when scheduling print jobs, such as scheduling print jobs into a time slot in the printing schedule where the print job may be completed without interruption.

The features and processes used by calendar application 300 are disclosed in greater detail below. Calendar application 300 enables production printing and planning using job queue 124 in DFE 106 and the print jobs within the queue. Calendar application 300 performs interactive planning using actual print jobs as opposed to scheduled information. Further, DFE 106 may include multiple job queues 124 such that estimation module 302 is estimating production times for dozens, hundreds, or more print jobs. Calendar application 300 takes into account a corresponding large number of production times for the print jobs when defining the printing schedule shown in printing schedule interface 306.

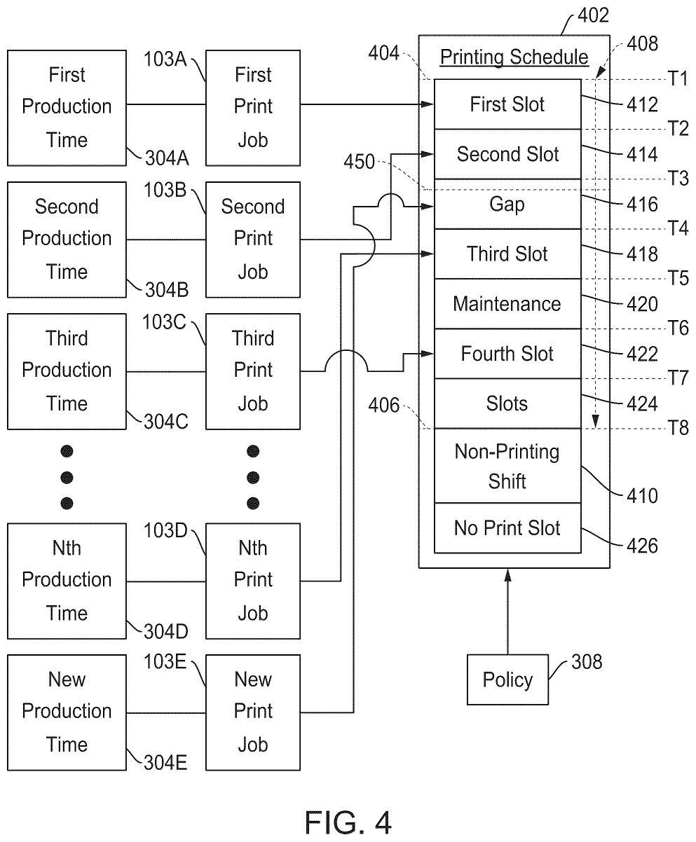

FIG. 4 depicts a block diagram of a defined printing schedule 402 to schedule print jobs using information derived from job queue 124 according to the disclosed embodiments. Printing schedule 402 may be defined, or generated, by calendar application 300 using production times estimates for print jobs within one or more job queues 124. It should be noted that even though FIG. 4 shows a small number of print jobs, printing schedule 402 may include dozens or hundreds of print jobs scheduled for printing at printing device 104.

Printing schedule 402 may be divided into a printing shift 408 and a non-printing shift 410. Printing shift 408 is when print jobs may be printed on printing device 104. Non-printing shift 410 is when no printing operations occur on printing device 104, such as when the print shop is closed or system 100 is not active. Printing shift 408 may start at start time 404 and end at stop time 406.

Calendar application 300 may define a pattern of available work hours for printing device 104, such as how recurring meetings are scheduled. Calendar application 300 may specify the following settings of working days and holidays. Working days may be days of the week during which printing device 104 is expected to be available. Printing schedule 402 reflects one of these days. Printing schedule 402 may include printing shifts 408 and non-printing shifts 410 for the entire week as opposed to a day. Holidays may be days that are exceptions to the above pattern. Calendar application 300 may skip these days. Calendar application 300 also may skip days with events when planning production. An option may be provided to allow operators to subscribe for notification when these exceptions are added by calendar application 300.

For each workday, calendar application 300 may specify start time 404 and stop time 406. Start time 404 and stop time 406 may vary everyday so that calendar application 300 takes these variances into account. For example, Saturdays may be part of the work week and a workday according to calendar application 300. Saturdays, however, start later and end earlier than the other workdays so that its start time 404 and stop time 406 differ from other days within calendar application 300.

Working hours, or times that printing device 104 is available for printing operations, may be defined as printing shift 408. Non-working hours for a given day may be defined by non-working shift 410. Further, calendar application 300 may specify meetings or items that represent non-working hours during the day. For example, lunch or another break within the work day may be designated as a non-working shift 410, or, alternatively, a scheduled downtime for printing device 104.

Calendar application 300 may allow the operators to subscribe to a normal calendar to define non-work hours, or non-working shift 410. This feature allows operators to plan non-work hours using any related application on their devices as calendar application 300 executes on printing device 104, not the devices, such as client device 102, of the operators. Calendar application 300 may skip these times when defining printing schedule 402.

In some embodiments, operators and devices may subscribe to calendar application 300 for updates and changes in printing shift 408 and non-printing shift 410. As print jobs are scheduled within printing schedule 402 by calendar application 300, notifications may be sent to the calendar applications used by the operators or hosted on client devices 102 from calendar application 300. The notifications may be sent on a subscription basis from calendar application 300 at DFE 106 of printing device 104. In other words, printing device 104 is sending notifications and updates via subscription regarding its printing schedule 402. This feature differs from normal print job scheduling operations.

Within printing shift 408 are time, or printing, slots. In most instances, time slots are not defined. In other words, the number of time slots and duration of each time slot varies throughout printing shift 408. Printing shift 408, however, is defined between start time 404 and stop time 406. The number of time slots within printing shift 408 corresponds to the number of print jobs that are scheduled by calendar application 300 to be printed. Calendar application 300 schedules print jobs to be printed with printing schedule 402 according to the production times for the print jobs and according to policy 308.

For example, first print job 103A may be scheduled by calendar application 300 within a first slot 412 that starts at time T1 and is estimated to print within first production time 304A, which ends at time T2. Second print job 103B may be scheduled by calendar application 300 to start printing at time T2, after completion of printing operations for first print job 103A. Second print job 103B is estimated to print within second production time 304B, which ends at time T3. Times T2 and T3 may vary depending on the situation in printing first print job 103A or second print job 103B. If there is some delay in processing these jobs, then calendar application 300 will move time T2 or time T3, accordingly.

Calendar application 300 also may take into account specified times for specific print jobs when defining printing schedule 402. These print jobs may be known as pinned print jobs in that they are assigned times within printing schedule 402 that may not be moved due to delays or other issues within the printing schedule. For example, Nth print job 103B may be a pinned print job having a specified time T4 for printing operations to begin. This time also may correspond to a third slot 418 defined by calendar application 300. Calendar application 300 allocates time for printing operations according to Nth production time 304D, or until time T5.

Specified times may be given for print jobs due to parameters that require certain features that are available at those times. Further, a customer may expect completion of the print job at a specific time. In some embodiments, printing device 104 includes media, such as paper 114 in first paper tray 108 that is required to complete the print job. These jobs are pinned to the specified times in printing schedule 402.

For third print job 103C, it may need to be shifted to another time slot within printing schedule 402 based on the specified time for processing Nth print job 103D. For example, third production time 304C, as estimated, may exceed the amount of time within printing schedule 402 available between time T3, or the estimated end of processing print job 103B, and time T4, or the specified time to print Nth print job 103D. Thus, calendar application 300 may schedule third print job 103C to begin printing operations at the first time available after completion of Nth print job 103D, which may be time T6. Fourth slot 422 may be defined within printing schedule 402 for third print job 103C.

A maintenance slot 420 may be defined within printing schedule 402 for periodic maintenance on printing device 104. It also may allow an operator to refill paper trays or change media. Maintenance slot 420 may be scheduled, or pinned, within printing schedule 402. Alternatively, it may take place after completion of a number of print jobs within job queue 124 based on the estimated resources needed for each job, such as the number of sheets, ink, toner, and the like.

New print job 103E is received within job queue 124. Alternatively, new print job 103E may be within job queue 124 but considered for printing schedule 402 after first print job 103A to Nth print job 103D. Calendar application 300 may determine that gap 416 between second slot 414 for second print job 103B and third slot 418 for Nth print job 103D exists. Gap 416 may exist between time T3 at the estimated completion of second print job 103B and the start of printing operations for Nth print job 103D within defined third slot 418 of printing schedule 402.

As a result, calendar application 300 determines that new production time 304E estimated for new print job 103E is within the amount of time defined for gap 416. In other words, new print job 103E may be processed and printed in the time period between time T3 and time T4. Thus, calendar application 300 defines a time slot for new print job 103E within gap 416. Calendar application 300 also reorders the print jobs within job queue 124 to place new print job 103E behind first print job 103A and second print job 103B, but in front of third print job 103C and Nth print job 103D. Thus, the order of print jobs within job queue 124 of DFE 106 may be reordered based on printing schedule 402 defined by calendar application 300.

Printing schedule 402 also includes a plurality of slots 424 between time T7 and time T8. Multiple print jobs may be processed in plurality of slots 424. Further, time T7 may be moved as previous print jobs are completed. As operations complete, current time line 450 may move along printing schedule 402 as displayed within printing schedule interface 306. Calendar application 300 moves current time line 450 in real time to show where in printing schedule 402 that printing device 104 is. Further, calendar application 300 may move times as current time line 450 moves within printing schedule 402 to update estimated times and the schedule based on delays, slower speeds in printing operations, and the like.

As disclosed above, production penalties 310 and maintenance penalties 312 may manifest themselves as printing operations are completed at printing device 104. These penalties may be estimated with the production times estimated for print jobs. Alternatively, they may be accounted for during printing operations within printing shift 408. For example, production penalty 310 may occur during the processing of Nth print job 103D within third slot between times T4 and T5. If third print job 103C had been printing between these times, then production penalty 310 would be included in third production time 304C. Thus, calendar application 300 may account for delays in scheduling print jobs and defining printing schedule 402 as well are reordering job queue 124 as a result.

As current time line 450 moves within printing schedule 402, calendar application 300 may determine that a print job cannot be printed within its slot. For example, new print job 103E is assigned to be printed in the period between time T3 and time T4, or gap 416. Delays in processing second print job 103B causes second slot 414 to move its estimated stop time at time T3 further down in printing schedule 408. Calendar application 300 determines that new production time 304E estimated for new print job 103E will exceed the time available between adjusted time T3 and time T4 for starting printing operations for third slot 418, or Nth print job 103D.

As a result of the adjustment within printing schedule 402, new print job 103E may be moved from its slot to another time, such as one within plurality of slots 424. Gap 416 now exists again within printing schedule 402. Another print job may be scheduled during that time by calendar application 300. Calendar application 300 replaces a moved print job with a new print job according to the disclosed embodiments. Alternatively, new print job 103E or third print job 103C may be moved to second slot 414 behind first slot 412 to begin printing operations at T2 if second print job 102B becomes unavailable.

In some embodiments, calendar application 300 may split printing operations for a print job between printing times, or slots, within printing schedule 402. For example, first print job 103A in first slot 412 may experience delays during printing operations. As current time line 450 moves within printing schedule 402, calendar application 300 updates estimated production times based on feedback from print engine 260 and job queue 124. Using the example, time T2 for beginning second slot 414 defined from second print job 103B may be moved further down within printing schedule 402.

At some point, calendar application 300 determines that second production time 304B estimated to complete second print job 103B exceeds the amount of time between time T2 to start second slot 414 and time T4 for the start for printing Nth print job 103D at a specified time within printing schedule 402. Calendar application may split printing operations so that a first part of printing second print job 103B is done within second slot 414 defined for second print job 103B. A second part of printing second print job 103B may be defined elsewhere in printing schedule 402, such as one of plurality of slots 424. If fourth slot 422 is not defined for third print job 103C, then the second part may be defined after time T6. Thus, a print job may be printed within two slots of printing schedule 402.

Calendar application 300 also may consider policy 308 in defining time slots for print jobs within printing schedule 402. Policy 308 may include one or more statements or rules governing how print jobs are to be treated in defining printing schedule 402. For example, policy 308 may include a rule to ensure job contiguity so that print jobs are scheduled into a time period in printing shift 408 so that the print job may be processed without interruption. For example, new print job 103E may be assigned to gap 416 if its estimated new production time 304E will allow it to be printed between times T3 and T4. If not, then policy 308 would dictate that calendar application 300 define a time for printing new print job 103E elsewhere, such as one of plurality of slots 424.

If multiple print jobs may be scheduled within gap 416, then policy 308 may instruct calendar application 300 to schedule the print job that does not require a media change or minimizes a media change. For example, third print job 103C and new print job 103E may fit within times T3 and T4 of gap 416. Third print job 103C would require a media change, which introduces a production penalty 310 into third production time 304C. New print job 103E does not require a media change after second print job 103B. Thus, calendar application 300 schedules new print job 103E into gap 416.

Policy 308 also may provide instructions to calendar application 300 to print jobs in a defined sequence. For example, print jobs that cannot be completed before non-work hour meetings are automatically divided into multiple appointments within printing schedule 402. As disclosed above, a print job may be divided into two slots to minimize gaps in printing schedule 402. Alternatively, policy 308 may allow for stop time 406 to be adjusted, or a time before a non-work slot, such as maintenance slot 420, to be adjusted to accommodate the print job.

For example, time T5 may be moved downwards within printing schedule 402 if the print job assigned in defined third slot 418 goes longer than estimated by its production time. Policy 308 may instruct calendar application 300 to make this adjustment. In other embodiments, non-printing shift 410 may include a no print slot 426. Policy 308, however, may move a print job to no print slot 426, or at least define a print job to be processed during that time period. Policy 308 also may distinguish between non-work time in making decisions. For example, time T5 may moved but time T8 for stop time 406 of printing shift 408 may not be moved.

Policy 308 also may enable “one-click” optimizations to reduce the amount of down time of printing device 104 within printing schedule 408. Policy 308 may specify to calendar application to minimize idle time by ensuring that all work hours within printing shift 408 are filled as much as possible. Thus, calendar application 300 may have settings in policy 308 related to print job completion. For example, policy 308 may specify that a print job must start production within a certain amount of time after it is received at printing device 104 or within job queue 124. Parameters 128 also may be used to determine deadlines that calendar application 300 may use to define a time slot or time period to schedule the print job.

It should be noted that use of the term time slots or slots does not include that these slots are defined within printing schedule 402 before receipt of print jobs within job queue 124. These terms are used to show that print jobs are scheduled at times within printing schedule. A time slot is defined by calendar application for each print job. The defined time slots are adjusted, deleted, and created according to the information retrieved from the print jobs within job queue 124 by calendar application 300.

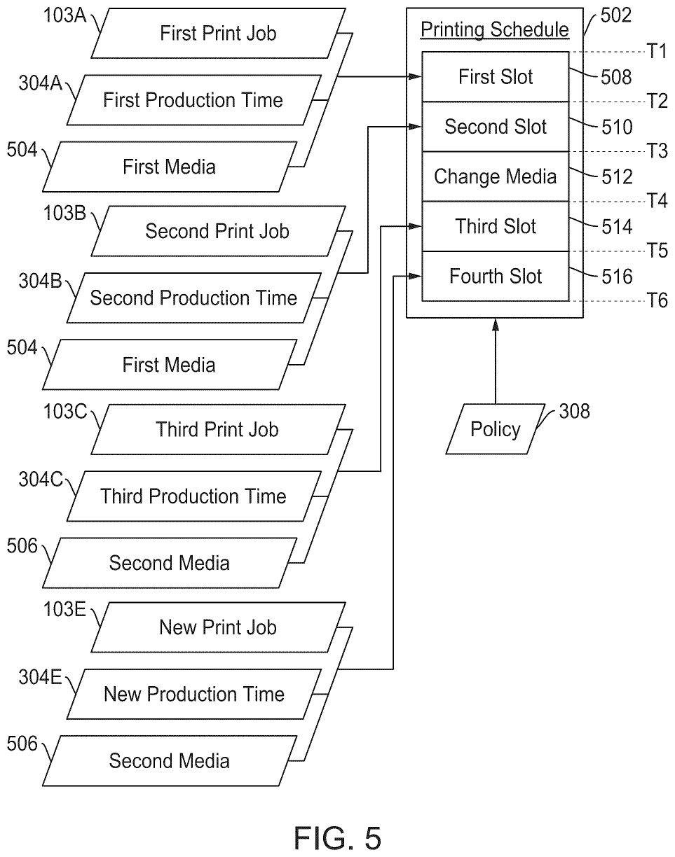

FIG. 5 depicts a block diagram of another defined printing schedule 502 to schedule print jobs using information derived from job queue 124 according to the disclosed embodiments. Printing schedule 502 may corresponding to printing schedule 402 in that it includes a printing shift 408 and non-printing shift 410, not shown in FIG. 5 for brevity. Further, printing schedule 502 also includes a start time 404 and stop time 406 for its printing shift 408.

Policy 308 may instruct calendar application 300 to schedule print jobs within printing schedule 502 as sets that minimize media changes on printing device 104. For example, first print job 103A and second print job 103B may use first media 504. First media 504 may be a specified type of paper or a specified size. Parameters 128A for first print job 103A and parameters 128B for second print job 103B may specify first media 504 for use at printing device 104. First paper tray 108, second paper tray 110, up to Nth paper tray 112 may include papers corresponding to first media 504.

Third print job 103C and new print job 103E, however, use second media 506 as its paper. Second media 506 differs from first media 504. For example, second media 506 may have a smaller sheet size them first media 504. Policy 308 may instruct calendar application 300 to schedule sets of print jobs according to common media. Thus, a first set of print jobs will include first print job 103A and second print job 103B. A second set of print jobs will include third print job 103C and new print job 103E.

Calendar application 300 may define two time slots within printing schedule 502 for the first set of print jobs and two time slots for the second set of print jobs. First print job 103A may be scheduled, or have an appointment, at time T1 to begin printing operations in first time slot 508. The estimated period of time for time slot 508 depends on first production time 304A. The estimated production time is used to define time T2 when first print job 103A should end and second print job 103B should start. Second production time 304B then may be used to define second time slot 510 for second print job 103B. First media 504 is used for printing operations at printing device between time T1 and time T3, when second print job 103B is estimated to be complete.

Calendar application 300 may schedule a change media slot 512 to allow for first media 504 to be replaced by second media 506. Thus, the time period between time T3 and time T4 may be a production penalty 310 in that it is not related to parameters of first print job 103A and second print job 103B, but to operations at printing device 104. Calendar application 300 then schedules third print job 103C and new print job 103E in printing schedule 502. Third time slot 514 may be defined between times T4 and T5. Time T4 also represents the estimated completion of change media slot 512. Time T4 may be adjusted by calendar application 300 during operations to account for any additional delay in switching to second media 506. New print job 103E also uses second media 506 and is scheduled in fourth time slot 516 between times T5 and T6 based on its new production time 304E.

As disclosed above, first media 504 may be larger than second media 506. Policy 308 may instruct calendar application 300 to schedule sets of print jobs having the larger media before sets of print jobs having smaller media. Conversely, if second media 506 is larger that first media 504, then third print job 103C and new print job 103E may be scheduled before first print job 103A and second print job 103B. In other words, third print job 103C may be scheduled in first time slot 508 and new print job 103E scheduled in second time slot 510, with times T1, T2, and T3 adjusting according to first production time 304A and second production time 304B, respectively.

In another example, new print job 103E may use first media 504. Policy 308 then may specify that new print job 103E be included in the set of print jobs using first media 504 and printed before any print jobs using second media 506. Thus, third slot 514 may be moved before change in media slot 512 as no media change needs to take place. New print job 103E is placed into the newly defined time slot. Third print job 103C still uses print media 506 and, therefore, prints in printing schedule 502 after the new change at printing device 104.

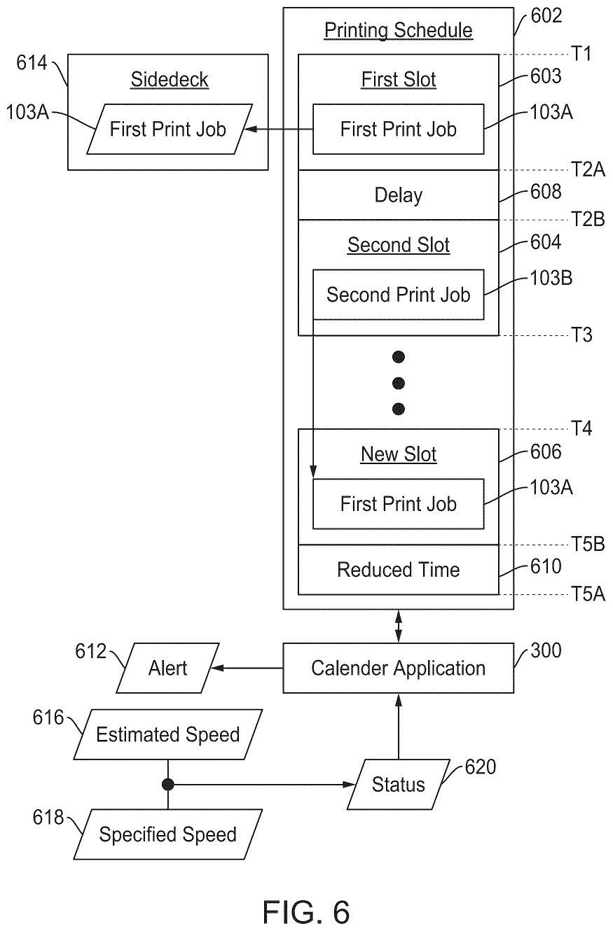

FIG. 6 depicts a block diagram of another defined printing schedule 602 to schedule print jobs according to the disclosed embodiments. Printing schedule 602 also may corresponding to printing schedule 402 in that it includes a printing shift 408 and non-printing shift 410, not shown in FIG. 6 for brevity. Further, printing schedule 602 also includes a start time 404 and stop time 406 for its printing shift 408.

Printing schedule 602 includes the print jobs scheduled within time slots at times. For example, first print job 103A may be scheduled to start printing operations at time T1. Thus, a first time slot 603 may be defined for first print job 103A to print within a time period starting at time T1 and continuing to a time T2A based on first production time 304A estimated for the first print job. If printing operations go as estimated, then first print job 103A will complete printing operations at time T2A.

According to the disclosed embodiments, the appointments for specific print jobs are updated based on action job production time. If production stops for first print job 103A, then first time slot 603 continues to grow as long as processing is paused. Similarly, if first print job 103A does not render or print at an estimated speed 616 for print engine 260, then calendar application 300 may extend first time slot 603 from time T2A to a later time, such as time T2B. Calendar application 300 may determine estimated speed 616 for print engine 260 is below a specified speed 618 set for printing device 104. For example, specified speed 618 may be 50 sheets per minute. If estimated speed 616 is below this threshold, such as 40 sheets a minute, then calendar application 300 would update the estimated time for first time slot 603 to complete printing operations for first print job 103A.

If first time slot 603 is extended, then a print job scheduled afterwards within printing schedule 602 also is adjusted. For example, second print job 103B may be scheduled by calendar application 300 in a defined second time slot 604. Before delay 608, second time slot 604 is scheduled by calendar application 300 to starting printing operations for second print job 103B at time T2A. Due to delay 608, the start time for second time slot 604 is moved to time T2B, or later in printing schedule 602. Other print jobs also may be rescheduled down later within printing schedule 602. Thus, second print job 103B may be automatically rescheduled within printing schedule 602 because of delay 608.

Delay 608 may be caused by a status 620 within printing device 104. In addition to delays caused by slower than specified speeds, other forms of delay may include a pause in printing operations at printing device 104. Status 620 indicates a pause at printing device 104 to calendar application 300. The pause may be for addressing a problem at printing device 104, such as a paper jam. Further, printing may be paused to refill paper trays and other similar actions. Status 620 also may correspond to a slower printing speed using estimated speed 616 and specified speed 618, disclosed above. Calendar application 300 may consider status 620 in effect at printing device 104 until it is removed by a condition being met within the printing device. For example, DFE 106 may determine that the pause is removed and updates status 620, accordingly, so that calendar application 300 does not need to continue adjusting printing schedule 602.

If second time slot 604 is extended into non-work hours, such as non-printing shift 410, then calendar application 300 may split second print job 103B into multiple time slots, or appointments, within printing schedule 602, as disclosed above. For example, second time slot 604 may be split between processing at a time T2B and a time T3 and processing within a time period within printing schedule 602, such as between time T4 and time T5A. In other embodiments, the processing, or production, time may be adjusted. In other words, time T3 to complete second print job 103B may be moved. In some embodiments, second time slot 604 may extend into the non-work hours. Referring to FIG. 4, second time slot 604 may extend past time T8.

In still further embodiments, if the processing time for second print job 103B cannot be accommodated within printing schedule 602, then second print job 103B may be cancelled. Calendar application 300 may notify the operator using an alert 612 to user interface 120. Second print job 103B may be rescheduled to a different printing shift 408 during a subsequent work day. Calendar application 300 now may fill the time vacated by the cancellation of second print job 103B with another print job, such as third print job 103C provided third production time 304C is estimated to be less than second production time 304B for second print job 103B.

As may be appreciated, job queue 124 may be updated following any switching or adjustments may by calendar application 300. If second print job 103B is cancelled and replaced with third print job 103C in printing schedule 602, then calendar application 300 may instruct DFE 106 to adjust the order of job queue 124 to be consistent with any changes made to the printing schedule.

In some embodiments, a print job may need to be removed from printing schedule 602 but not cancelled. In other words, the production time of the print job may be paused or put on hold within printing schedule 602. The print job is not removed from job queue 124, however, but may be adjusted within the queue. For example, first print job 103A is removed from its defined first time slot 603. It may be placed into a sidedeck 614, which is visible within printing schedule interface 306. The operator may drag and drop an icon for first print job 103A into a field for sidedeck 614 within printing schedule interface 306. First print job 103A is removed from printing schedule 602. A new time slot may be defined starting at time T1 for another print job. For example, second print job 103B may be moved within printing schedule 602 to start at time T1.

At some point, first print job 103A is removed from sidedeck 614 and a holding status to be placed back into printing schedule 602. A new time slot 606 may be defined within printing schedule 602 based on an available start time and first production time 304A. Calendar application 300, however, makes sure that it does not define a time slot that overlaps or interferes with the time slot, or production time, for the rescheduled second print job 103B. Thus, new time slot 606 is defined to start at time T4, which is after time T3 for completion of second print job 103B.

It may be appreciated that times allocated for production or printing operations may be reduced. For example, estimated speed 616 may be greater than a specified speed 618 such that print jobs are being completed ahead of their estimated production times. For example, estimated speed 616 may be 70 sheets per minute, which is greater than 50 sheets per minute for specified speed 618. Rescheduled first print job 103A, therefore, may be completed at time T5B instead of time T5A. A reduced time 610 may be determined and applied by calendar application 300 when scheduling other print jobs within printing schedule 602.

In other embodiments, calendar application 300 may determine that a print job cannot be completed in its defined time slot, or period of time corresponding to the estimated production time. For example, first print job 103A is scheduled to be printed between times T1 and T2A as defined by first slot 603. Delay 608 or another condition may occur that prevents first print job 103A being printed within first time slot 603. The additional time prevents first print job 103A from being completed. For example, second print job 103B may be pinned or specified to print at time T2A such that second time slot 604 may not be adjusted. The rest of printing schedule 602 is full or set so that first print job 103A cannot be inserted in a gap or other slots defined within the schedule.

In these instances, calendar application 300 may send an alert 612 using DFE 106 that first print job 103A is not able to be processed or printed at time T1. In some embodiments, first print job 103A may be moved to sidedeck 614 by calendar application 300 so that an operator can find its icon within printing schedule interface 306. First print job 103A then may be rescheduled to a newly defined time slot, or new time slot 606. If, after further processing of print jobs within printing schedule 602, it is determined that first print job 103A still may not be completed during its fixed processing time estimated by first production time 304A, then another alert 612 may be sent by calendar application 300.

In this manner, the disclosed embodiments may adjust print jobs automatically using calendar application 300 so that delays and other conditions will result in print jobs being rescheduled to better utilize printing schedule 602. Instead of delays carrying forward, print jobs may be rescheduled or even cancelled so that printing time at printing device 104 is maximized.

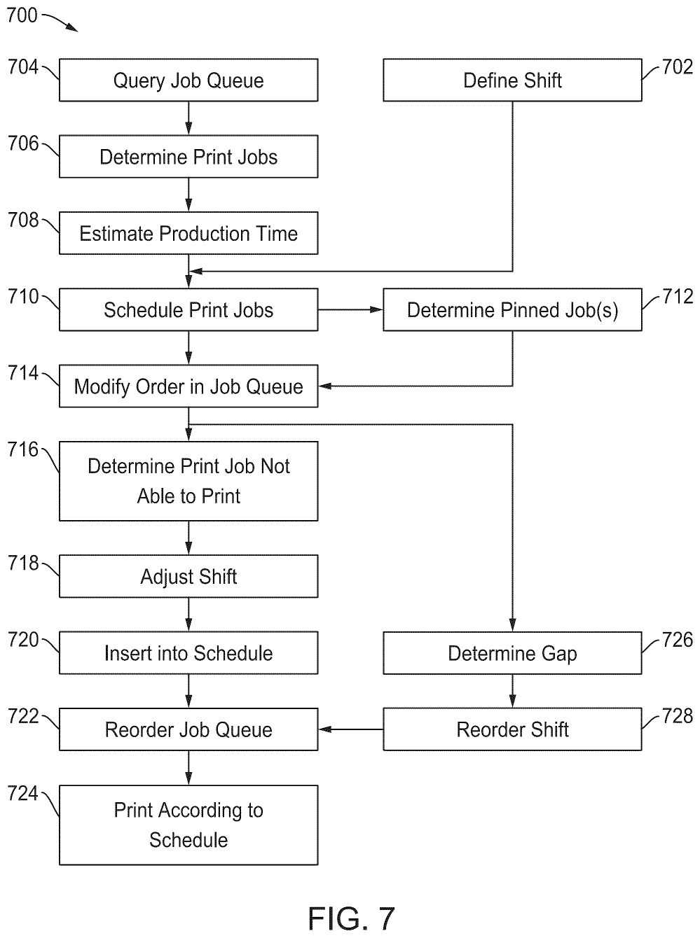

FIG. 7 depicts a flowchart 700 for managing printing operations using calendar application 300 at printing device 104 according to the disclosed embodiments. Flowchart 700 may refer to FIGS. 1A-6 for illustrative purposes. Flowchart 700, however, is not limited to the embodiments disclosed by FIGS. 1A-6.

Step 702 executes by defining printing shift 408 within a printing schedule, such as printing schedule 402, 502, or 602, for using printing device 104 for printing operations. Printing shift 408 includes start time 404 and stop time 406 for printing operations. Within printing shift 408, one or more time, or printing, slots will be defined by calendar application 300 using printing schedule 402, 502, or 602. Non-printing shift 410 may be defined as the non-work hours. Other non-work hours may be defined, including some in printing shift 408, such as maintenance slot 420. Flowchart 700 may proceed to step 710, disclosed below.

Step 704 executes by querying job queue 124 at DFE 106 of printing device 104. Calendar application 300, for example, may query job queue 124. Step 706 executes by determining one or more print jobs within job queue 124. Each print job may be a separate job having different parameters 128, such as job parameters, specific to the respective print job. Step 708 executes by estimating a production time for printing each print job in job queue 124 at printing device 104. As disclosed above, estimation module 302 may estimate first production time 304A for first print job 103A, second production time 304B for second print job 103B, and so on. A new print job 103E received in job queue 124 will have a new production time 304E estimated for use in scheduling printing operations according to the disclosed embodiments.

Step 710 executes by scheduling the one or more print jobs in job queue 124 within printing shift 408. Calendar application 300 may define a time slot for each print job within printing shift 408 according to the respective production time. For example, if first print job 103A has a first production time of 15 minutes, then calendar application 300 may define a time slot of 15 minutes to be placed within printing shift 408 of printing schedule 402, 502, or 602. If second print job 103B has a second production time of 25 minutes, then calendar application may define a time slot of 25 minutes to be placed within printing shift 408.

Step 712 executes by determining if any of the print jobs are pinned, or specify a fixed time slot at a specified time within printing shift 408. If so, then those print jobs are “pinned” or added to printing schedule 402, 502, or 602 at the specified or fixed time. The respective production time for printing the print job also may be accounted for in printing shift 408. A pinned print job may not be moved by calendar application 300 when defining printing schedule 402, 502, or 602. It may, however, be moved by an operator to another time slot.

Step 714 executes by modifying an order of the print jobs in job queue 124 to reflect the scheduled times within printing schedule 402, 502, or 602. For example, a print job may be pinned, or fixed, to a specified time, such as 2 pm, within printing shift 408. This print job may have an estimated production time of 90 minutes. Another print job ahead of the fixed print job may not be done printing operations before 2 pm based on its estimated production time. Thus, the other print job is moved within the printing schedule so that the fixed print job is not moved. In other embodiments, as disclosed above, a policy 308 may specify that print jobs using a common media or settings be printed together. Other examples are disclosed above.

As calendar application 300 determines an order of printing within the printing schedule for printing shift 408, it optimizes the amount of unused time at printing device 104. Thus, the scheduling of print jobs may be moved to reduce the time devoted to gaps or delays in printing operations. Once printing schedule 402, 502, or 602 is defined, the order of print jobs within job queue 124 may be modified to reflect the schedule. For example, if third print job 103C is printed between first print job 103A and second print job 103B according to printing schedule 402, then job queue 124 will modify the order within the queue to be first print job 103A, third print job 103C, and second print job 103B.

Step 716 executes by determining a print job is not able to print within printing shift 408. Printing shift 408 is based on a plurality of print jobs scheduled to be printed. For example, first print job 103A may not be able to be printed based on a condition at printing device 104. Alternatively, a paper media may not be available until later in printing shift 408. For whatever reason, the disclosed embodiments indicate that first print job 103A is not able to printed. Calendar application 300 must take action accordingly.

Step 718 executes by adjusting printing shift 408 within printing schedule 402, 502, or 602 to accommodate the removal of the print job, such as first print job 103A. The remaining print jobs may be adjusted to reduce any gap in printing operations. For example, using the above order of print jobs, third print job 103C may be moved to the time previously allocated to first print job 103A. Third print job 103C includes third production time 304C, which may be larger or smaller than first production time 304A. A gap in the printing schedule for printing shift 408 may be created that can be reduced by moving another print job into the gap. Second print job 103B, however, may not be moved or adjusted if it is fixed to a pinned time slot within the printing schedule.

Step 720 executes by inserting the removed print job into a new time slot within printing shift 408. Calendar application 300 inserts the print job into a time slot or start time that reduces the amount of a gap, such as gap 416, in the printing schedule. Thus, when determining where to reintroduce a removed print job back into the printing schedule, the disclosed embodiments determines a configuration that results in the smallest amount of unused time at printing device 104 and modifies the printing schedule accordingly.

Step 722 executes by reordering the print job within job queue 124 based on the modified printing schedule. For example, first print job 103A may be inserted back into printing schedule 402 at time T7 using a new time slot defined using first production time 304A. This time slot is after printing operations for new print job 103E. Thus, job queue 124 is reordered to place first print job 103A after new print job 103E at time T7.

In some embodiments, step 726 may execute by determining a gap, such as gap 416, in printing shift 408. More than one gap may be determined. Referring to printing schedule 402, gap 416 may occur between second time slot 414 and third time slot 418. Calendar application 300 reorders the plurality of print jobs to reduce the amount of time allocated to gap 416. For example, a print job within job queue 124 after the print job assigned to third time slot 418 may be moved from later in printing schedule 402 to time T3 when gap 416 begins. A print job may be split and have a portion of its printing operations executed in gap 416. Step 728 executes by reordering printing shift 728 to reflect the changes in the printing order based on reducing gap 416. Flowchart 700 then proceeds to step 722, as disclosed above.

Step 724 executes by printing the print jobs within job queue 124 according to printing schedule 402, 502, or 602. For example, if printing schedule 402 modifies the order of print jobs within job queue 124 to be third print job 103C, new print job 103E, second print job 103B, Nth print job 103D, and first print job 103A, then printing device 104 performs printing operations for each job in this order. Media changes and other actions may occur according to this order. It should be noted that the printing schedule is generated automatically based on calendar application 300 without the need for an operator to move jobs around or try to figure out the optimum way to schedule jobs.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing printing operations at a printing device, the method comprising:
querying a job queue at a digital front end (DFE) of the printing device to determine a plurality of print jobs within the job queue, wherein the plurality of print jobs is in an order within the job queue;
estimating a production time to print each print job of the plurality of print jobs in the job queue at the printing device;
defining a shift in a defined printing schedule for using the printing device to print the plurality of print jobs, wherein the shift includes a start time and a stop time for printing operations at the printing device and wherein the shift includes a plurality of time slots between the start time and the stop time;
scheduling the plurality of print jobs within the shift of the defined printing schedule using the plurality of time slot according to the production time for each print job within the DFE, wherein the order within the job queue is modified based on the plurality of time slots for the plurality of print jobs;
indicating a first print job is not able to be printed within the shift based on the scheduled plurality of print jobs;
adjusting the shift within the defined printing schedule;
inserting the first print job into a time slot within the shift, wherein an amount of unused time within the shift is reduced; and
reordering the first print job within the job queue of the DFE.

2. The method of claim 1, further comprising generating the defined printing schedule for the printing device, wherein the defined printing schedule includes a first portion identified as at least one time slot for processing print jobs at the printing device and a second portion identified as at least one time slot for not processing print jobs at the printing device.

3. The method of claim 2, wherein the shift is defined in the first portion of the defined printing schedule.

4. The method of claim 1, further comprising
determining a gap between a first time slot and a second time slot in the shift; and
reordering the plurality of print jobs within the shift to reduce a size of the gap.

5. The method of claim 4, further comprising reordering the plurality of print jobs within the job queue to match the order of print jobs within the shift.

6. The method of claim 1, further comprising printing the plurality of print jobs at the printing device according to the defined printing schedule.

7. The method of claim 1, further comprising printing the first print job at the printing device as specified within the defined printing schedule.

8. The method of claim 1, further comprising determining a second print job of the plurality of print jobs uses a fixed time slot within the defined printing schedule, wherein the fixed time slot does not change if the first print job being reordered causes a reordering of the plurality of print jobs.

9. The method of claim 1, wherein the first print job is a fixed print job such that a start time for the time slot is fixed to a specified time within the printing schedule.

10. The method of claim 9, wherein the first print job is set as the fixed print job when placed within the shift.

11. A method for managing printing operations at a printing device, the method comprising:
querying a job queue at a digital front end (DFE) of the printing device to determine a plurality of print jobs within the job queue, wherein the plurality of print jobs is in an order within the job queue;
estimating a production time to print each print job of the plurality of print jobs in the job queue at the printing device;
defining a shift in a defined printing schedule for using the printing device to print the plurality of print jobs, wherein the shift includes a start time and a stop time for printing operations at the printing device and wherein the shift includes a plurality of time slots between the start time and the stop time; and
scheduling the plurality of print jobs within the shift of the defined printing schedule using the plurality of time slot according to the production time for each print job within the DFE, wherein the order within the job queue is modified based on the plurality of time slots for the plurality of print jobs, wherein the scheduling includes
determining a first print job and a second print job of the plurality of print jobs include an attribute,
scheduling the first print job in a first time slot within the shift,
scheduling the second print job in a second time slot immediately following the first time slot, and
reordering the second print job within the job queue of the DFE.

12. The method of claim 11, wherein the attribute of the first print job and the second print job is a paper media.

13. The method of claim 11, wherein the attribute of the first print job and the second print job is a paper size.

14. The method of claim 11, wherein the attribute of the first print job and the second print job is an output bin of the printing device.

15. The method of claim 11, wherein the attribute of the first print job and the second print job is a job setting.

16. The method of claim 11, further comprising generating the defined printing schedule for the printing device, wherein the defined printing schedule includes a first portion identified as at least one time slot for processing print jobs at the printing device and a second portion identified as at least one time slot for not processing print jobs at the printing device.

17. A method for managing printing operations at a printing device, the method comprising:
querying a job queue at a digital front end (DFE) of the printing device to determine a plurality of print jobs within the job queue, wherein the plurality of print jobs is in an order within the job queue;
estimating a production time to print each print job of the plurality of print jobs in the job queue at the printing device;
defining a shift in a defined printing schedule for using the printing device to print the plurality of print jobs, wherein the shift includes a start time and a stop time for printing operations at the printing device and wherein the shift includes a plurality of time slots between the start time and stop time;
determining at least one gap having an amount of time between at least two time slots within the plurality of time slots based on an order of the plurality of print jobs within the job queue of the DFE;
automatically reordering the plurality of print jobs within the plurality of time slots of the defined printing schedule to reduce the amount of time of the at least one gap between the at least two time slots; and
changing the order of the plurality of print jobs within the job queue of the DFE to correspond to the reordered plurality of print jobs within the defined printing schedule.

18. The method of claim 17, further comprising generating the defined printing schedule for the printing device, wherein the defined printing schedule includes a first portion identified as at least one time slot for processing print jobs at the printing device and a second portion identified as at least one time slot for not processing print jobs at the printing device.

19. The method of claim 17, wherein automatically reordering the plurality of print jobs includes
determining a first print job and a second print job of the plurality of print jobs include an attribute,
scheduling the first print job in a first time slot within the shift,
scheduling the second print job in a second time slot immediately following the first time slot, and
reordering the second print job within the job queue of the DFE.

20. The method of claim 17, further comprising printing the plurality of print jobs at the printing device according to the defined printing schedule.
